(19) United States
(12) Patent Application Publication
(10) Pub. No.: US 2015/0166860 A1
(43) Pub. Date: Jun. 18, 2015

(54) LIQUID OPTICALLY CLEAR PHOTO-CURABLE ADHESIVE FOR DISPLAY APPLICATION

(71) Applicants: Henkel (China) Co. Ltd, Shanghai (CN); Henkel IP & Holding GmbH, Duesseldorf (DE)

(72) Inventors: Yinxiao Yuan, Shanghai (CN); Daoqiang Lu, Chandler, AZ (US)

(21) Appl. No.: 14/626,000

(22) Filed: Feb. 19, 2015

Related U.S. Application Data
(63) Continuation of application No. PCT/CN2012/080359, filed on Aug. 20, 2012.

(51) Int. Cl. C09J 175/16; B32B 43/00; B32B 37/06; B32B 38/10; C09J 11/08; B32B 37/12

(52) U.S. Cl. CPC C09J 175/16; C09J 11/08; B32B 37/1284; B32B 37/06; B32B 38/10; B32B 43/006

(57) ABSTRACT

Liquid optically clear photo-curable adhesive for display application

A process for reworking an optical assembly and a liquid optically clear photo-curable adhesive, which comprises:
(a) 10 to 50 wt % of an urethane acrylate,
(b) 30 to 70 wt % of plasticizer,
(c) 0.002 to 5 wt % of photo initiator,
(d) 1 to 30 wt % of acrylate monomer
   are described.

The present invention relates to a specific liquid optically clear photo-curable adhesive and to several uses of this adhesive. It further relates to the bonding of substrates with a liquid optically clear photo-curable adhesive and it also relates to optical assemblies that include such optical clear adhesives. Further it relates to a process for reworking an optical assembly.

Optically clear adhesives and especially liquid optically clear adhesives are finding wide applications in optical displays. Optical bonding in display applications is used to bond optical elements such as display panels, glass plates, touch panels, diffusers, rigid compensators, heaters, and flexible films such as polarizers and retarders. Especially the use of such adhesives for bonding in touch displays, for example, capacitive touch displays is of high interest. The importance of optically clear adhesives is still growing since the continuous development of new electronic display products, such as wireless reading devices, increases the demands for optically clear adhesives. But there are still some challenges to be mastered.

One major challenge with this type of of optical assemblies is how to rework the LCD or other expensive parts after the lamination is completed, but a defect is identified. For example, end customers might return a defective display for warrantee repair. For these cases, the display manufacturers will have to take the display apart, remove the adhesive residue, and reuse the expensive functioning components such as LCD modules. For traditional liquid optically clear photo-curable adhesives, after the display is disassembled, the adhesive residues will be broken into tacky small pieces which stick on the components. Cleaning off the residue using organic solvent is not only very time-consuming, but also has serious environmental concerns and also affects occupational health and safety.

Therefore it was the object of this invention to make the rework of optical assemblies, which have been glued with a liquid optically clear photo-curable adhesive, more easy and practical. This problem was solved by the subject matter of our invention.

The subject matter of our invention is a liquid optically clear photo-curable adhesive, which comprises:

(a) 10 to 50 wt % of an urethane acrylate,

(b) 30 to 70 wt %, preferably 35 to 70 wt %, in particular 40 to 50 wt % of plasticizer,

(c) 0.002 to 5 wt %, preferably 0.02 to 3.5 wt % of photo initiator,

(d) 1 to 30 wt % of acrylate monomer.

The inventive optically clear adhesive has an outstanding film-forming capability. It forms an optically clear film after it is fully cured by radiation. The rework of optical assemblies, which have been glued with this inventive liquid optically clear photo-curable adhesive, is very easy and practical. During reworking, it is just needed to take apart the bonded components, as the case may be after heating to 50° C.-100° C., and peel off the adhesive film which normally stays on one side of the glued components. Therefore, the adhesive film is easily removable from the bonded components without leaving any residue on an optical assembly at all. The adhesive film can preferably be peeled away in just one single piece. The cured adhesive also has a very low elastic modulus, a very low hardness, a very low curing shrinkage and shows a high elongation.

Another advantage of our invention is that the inventive liquid optically clear photo-curable adhesive enables bonding of parts of optical assemblies, for example bonding the cover lens to a LCD module without any Mura problem. The cured adhesive can pass harsh reliability tests without imposing Mura to the LCD, for example exposure to 85° C. for 1000 hours or exposure to −40° C. for 1000 hours. Normally, Mura is a key problem. “Mura” is a Japanese term for “unevenness.” Dark spots or patches may occasionally appear on some liquid crystal display (LCD) panels. This clouding phenomenon is recognized as “Mura”. “Mura” is used to describe a low-contrast, irregular pattern or region that causes uneven screen uniformity under certain conditions. Mura is therefore a display effect and can be caused by stress imposed to the LCD. Any kind of stress, even at low level, might cause Mura to a LCD. Our invention offers the best possible prevention of Mura.

The term “liquid optically clear photo-curable adhesive” is well established in the art and well known to the person skilled in the art. Liquid optically-clear adhesive (LOCA) is widely used in touch panels and display devices to bind the cover lens, plastic or other optical materials to the main sensor unit or to each other. Liquid optically-clear adhesives are generally used to improve the optical characteristics of the device as well as improve other attributes such as durability. The liquid optically clear photo-curable adhesive is generally used for example to bond the touch panel to the main liquid crystal display, and also to bond any protective cover, such as the lens, to the touch panel. Major applications of liquid optically clear photo-curable adhesive include capacitive touch panels, 3D televisions and glass retarders. In particular the adhesive is optically clear, if it exhibits an optical transmission of preferably at least 85%. The measurement of optical transmission is known to the person skilled in the art. It can preferably be measured on a 100 μm thick sample according to the following preferred testing method.

Preferred testing method for transmission:

A small drop of optically clear adhesive is placed on a 75 mm by 50 mm plain micro slide (a glass slide from Dow Corning, Midland, Mich.), that had been wiped three times with isopropanol and has two 100 μm thick spacer tapes attached on its two ends. A second glass slide is attached onto the adhesive under a force. Then the adhesive is fully cured under a UV source. The optical transmission is measured from wavelength 380 nm to 780 nm with a spectrometer Cary 300 from Agilent. One blank glass slide is used as the background.

The inventive adhesive shows excellent optical performance even under harsh reliability condition. The adhesive shows no yellowing after various reliability conditions. The adhesive has a long shelf life and shows good processibility during lamination.

The inventive adhesive is suitable for application on uneven surfaces, can be used in large panels, is ideal for filling in gaps, avoids condensation and fogging, permits resistance to extreme temperatures, allow very thin display designs.

Urethane acrylates are well known to the person skilled in the art, they may for example be obtained by reaction of diisocyanates, preferably aliphatic diisocyanates, with hydroxyacrylates, or may for example be obtained by reaction of diisocyanates, preferably aliphatic diisocyanates, hydroxyacrylates and polyols.

The urethane acrylate preferably comprises multifunctional urethane (meth)acrylate oligomer. The urethane (meth)acrylate oligomer preferably comprises at least one (meth)acrylate group, e.g., from 1 to 4 (meth)acrylate groups. Multifunctional and in particular difunctional aliphatic urethane acrylate oligomers are preferred as urethane acrylates.

For example, the multifunctional urethane acrylate oligomer may be formed from an aliphatic polyester or polyether polyol prepared from condensation of a dicarboxylic acid, e.g., adipic acid or maleic acid, and an aliphatic diol, e.g. diethylene glycol or 1,6-hexane diol. In one embodiment, the polyester polyol may comprise adipic acid and diethylene glycol. The multifunctional isocyanate may comprise methylene dicyclohexylisocyanate or 1,6-hexamethylene diisocyanate. The hydroxy-functionalized acrylate may comprise a hydroxyalkyl acrylate such as 2-hydroxyethyl acrylate, 2-hydroxypropyl acrylate, 4-hydroxybutyl acrylate, or polyethylene glycol acrylate. In one embodiment, the multifunctional urethane acrylate oligomer may comprise the reaction product of a polyester polyol, methylene dicyclohexylisocyanate, and hydroxyethyl acrylate.

Suitable urethane acrylates, which can be used according to this invention, are for example aliphatic polyether urethane diacrylates, in particular BR-3042, BR-3641 AA, BR-3741 AB, and BR-344 available from Bomar Specialties Co., Torrington, Conn.

Other preferred aliphatic urethane acrylates are for example CN8004, CN-9002, CN-980, CN-981, CN9014, CN-9019, CN9021 available from Sartomer Companry Inc, Exton, Pa. Urethane acrylate resins such as Genomer 4188/EHA, Genomer 4269/M22, Genomer 4425, and Genomer 1122, Genomer 6043 from Rahn AG, Switzerland are preferred, too. Urethane Acrylate Oligomers are preferred, too, for example UV-3000B, UV-36301D80, UV-36301D80, UV-NS054, UV7000B, and UV-NS077 from NIPPON GOHSEI, Japan are preferred, as well as UC-203, UC-102 from Kuraray Company. Aliphatic urethane acrylate oligomers, like Doublemer 5222, Doublemer 5220, Doublemer 5700, Doublemer 5400, Doublemer 5500 from DOUBLE BOND CHEMICAL IND., CO., LTD, are preferred, too. Difunctional aliphatic polyester urethane acrylate oligomer as well as difunctional aliphatic polyester/ether urethane acrylate oligomer are preferred urethane acrylates, too.

According to a preferred embodiment of this invention the plasticizer comprises polyisoprene resin, polybutadiene resin, hydrogenated polybutadiene, xylene polymer, hydroxyl-terminated polybutadiene and/or hydroxyl-terminated polyolefin. Terpene polymer resin, phthalates, trimellitates, adipates, benzoate ester, hexanoate and/or dicarboxylate can be used as well. Of course other specialty plasticizers, which are available on the market, can also be used.

Suitable plasticizers like the polyisoprene resin, polybutadiene resin, hydrogenated polybutadiene, xylene polymer and so on may preferably have a number average molecular weight (Mn) of 50 to 50,000 and preferably a functionality of 0 to 1. Functionality means here the functional group which can participate in the curing reaction of acrylate, such as acrylate double bond. Hydroxyl group does not count as a functionality in this case.

Preferred polyisoprene resin and/or, polybutadiene resin, which can be used in this invention are for example Polybutadiene Polybd45CT, Polybd2000CT, Polybd3000CT, CN307 available from Sartomer Companry Inc, Exton, Pa. Polyisoprene LIR-30, LIR-50, LIR-290 available from Kuraray Co. Ltd, Tokyo, Japan can preferably be used, too. Polybutadiene TEA-1000, TE2000, GI-1000, GI-2000, GI-3000, BI-2000, BI-3000, JP-100, available from Nippon Soda Co Ltd, Tokyo, Japan can preferably be used, too. BI-2000, for example, is a hydrogenated 1,2-polybutadiene homopolymer with a number average molecular weight of around 2100. GI-2000, for example, is a hydroxy-terminated hydrogenated 1,2-polybutadiene, with a number average molecular weight of around 2100.

Other preferred plasticizers for example include Palatinol 810P, Palatinol DPHP, Plastomoll DNA from BASF Corporation, NJ, USA, and Admex 523 Polymeric Plasticizer, Admex 6996 Polymeric Plasticizer, TEG-EH plasticizer (Triethylene Glycol Bis(2-EthylHexanoate)), DOP plasticizer (Bis(2-Ethylhexyl) Phthalate) from Eastman Chemical Company, TN, USA.

Other preferred plasticizer is chosen from PB-950, PB-1300, PB-1400, PB-2000 and PB-2400, etc., that can be purchased from Daelim Corporation; Indopol Polybutene L50, H-7, H-8, H-35, H-50, H-100, H-300, H-1200, H-1500, H-1900, H-2100 and H-6000 and the like that can be purchased from BP, are also preferred.

Combinations of plasticisers, for example combination of Triethylene Glycol Bis(2-EthylHexanoate) and polybutadiene resin, are preferred.

According to a preferred embodiment of this invention the photo initiator is chosen from any one of follows or their combination: 1-hydroxycyclohexyl phenyl ketone, 2-methyl-1-[4-(methylthio)phenyl]-2-morpholino propan-1-one, 2-benzyl-2-N,N-dimethylamino-1-(4-morpholinophenyl)-1-butanone, combination of 1-hydroxy cyclohexyl phenyl ketone and benzophenone, 2,2-dimethoxy-2-phenyl acetophenone, the combination of bis(2,6-dimethoxybenzoyl-2,4,4-trimethylpentyl phosphine oxide and 2-hydroxy-2-methyl-1-phenyl-propan-1-one, bis(2,4,6-trimethyl benzoyl) phenyl phosphine oxide, 2-hydroxy-2-methyl-1-phenyl-1-propane, combination of 2,4,6-trimethylbenzoyldiphenyl-phosphine oxide and 2-hydroxy-2-methyl-1-phenyl-propan-1-one, 2,4,6-trimethylbenzoyldiphenylphosphine oxide.

According to a preferred embodiment of this invention the acrylate monomer is chosen from methyl(meth)acrylate, ethyl(meth)acrylate, butyl(methyl)acrylate, 2-(2-ethoxyethoxy) ethyl acrylate, tetrahydrofurfury (meth)acrylate, lauryl acrylate, isooctyl acrylate, isodecyl acrylate, 2-phenoxyethyl acrylate, 2-ethylhexyl(meth)acrylate, isobornyl(meth)acrylate, dicyclopentenyloxyethyl(meth)acrylate, dicyclopentadienyl(meth)acrylate, 2-hydroxyethyl(meth)acrylate, 2-hydroxypropyl(meth)acrylate, 2-hydroxybutyl(meth)acrylate, caprolactone acrylate, morpholine(meth)acrylate, hexanediol di(meth)acrylate, ethyleneglycol dimethacrylate, trimethylolpropane triacrylate, pentaerythritol tetraacrylate and combinations thereof.

It is also possible to apply an acrylate oligomer, which preferably has a T_{g} value from −80° C. to 100° C. The acrylate oligomer can preferably be made from (meth)acrylic monomers and can preferably have a weight average molecular weight (Mw) within the range of about 1000 to 15000. A preferred weight average molecular weight (Mw) can be around 2000.

Mw can be determined by GPC. Measurement of molecular weight via GPC is well known and widely adopted in the relevant art. In the measurement, polystyrene having a narrow molecular weight distribution may be used as standard, for example, and tetrahydrofuran may be used as the mobile phase, and the flowing speed, for example, may be 0.8 mL/min, and the column temperature for example, may be 35° C.

In general, (meth)acrylate refers to both acrylate and methacrylate functionality. In general, “acrylate” refers to both acrylate and methacrylate functionality. “Acrylic ester” refers to both acrylic ester and methacrylic ester functionality.

Our invention leads to adhesives with ultra low hardness and ultra low elastic modulus as already pointed out. Thus, according to a preferred embodiment of this invention the elastic modulus of the cured adhesive is <1.0·10⁴ Pa, preferably determined using photorheometry.

Elastic modulus measurement is well known to the person skilled in the art. Preferably, the measurement of elastic modulus can be done using photorheometry. This is a convenient and well established technique for measurement of elastic modulus and well known to the person skilled in the art.

A preferred photoreometric measurement, which can preferably be applied to measure the elastic modulus, works as follows:

The preferred photoreometric measurement is done using a Physica MCR301 Photorheometer from Anton Paar GmbH, Germany. The photorheometer has a pair of parallel plates and the bottom plate is made of quartz. An UV light (with UVA intensity of 93 mW/cm²) is shined from a high pressure mercury arc (HPMA) lamp through the bottom plate to cure the adhesive sandwiched (with an initial gap of 1.00 mm) between the parallel plates which adhesive is tested under an oscillation mode (with a fixed angular frequency of 30 rad/s and 0.5% strain). The modulus is recorded with UV curing time. A zero fixed normal force (Fn) is used so that the gap is automatically reduced to accommodate sample shrinkage during curing.

According to another preferred embodiment of this invention the hardness of the cured adhesive is <10 (shore 00), preferably ≦3 (shore 00), preferably determined in accordance with ASTM D 2240.

Hardness measurement in accordance with ASTM D 2240 is well known to the person skilled in the art. Preferably, the measurement of hardness can be done as follows:

The liquid optically clear adhesive is cured inside a container with a flat bottom. The amount of the adhesive is controlled so that the cured adhesive is about 6.4 mm thick. The specimen is placed on a hard flat surface. The indentor for the durometer (Model 1600 Dial-00 from Rex Gauge Co. Inc, IL, USA) is then pressed into the specimen making sure that it is parallel to the surface. The hardness is determined within one second of firm contact with the specimen.

According to another preferred embodiment of this invention the shrinkage of the cured adhesive is <1.5%, preferably ≦1%, preferably determined using photorheometry.

This curing shrinkage can preferably be determined using photorheometry. This is a convenient and well established technique for measurement of shrinkage and well known to the person skilled in the art.

A preferred photoreometric measurement, which can preferably be applied to measure the shrinkage, works as follows:

The preferred photoreometric measurement is done using a Physica MCR301 Photorheometer from Anton Paar GmbH, Germany. The photorhemeter has a pair of parallel plates and the bottom plate is made of quartz. An UV light (with UVA intensity of 93 mW/cm2) is shined from a high pressure mercury arc (HPMA) lamp through the bottom plate to cure the adhesive sandwiched (with an initial gap of 1.00 mm) between the parallel plates which adhesive is tested under an oscillation mode (with a fixed angular frequency of 30 rad/s and 0.5% strain). The modulus is recorded with UV curing time. A zero fixed normal force (Fn) is used so that the gap is automatically reduced to accommodate sample shrinkage during curing. Gap vs. cure is plotted to report linear curing shrinkage of the sample.

According to another preferred embodiment of this invention the elongation of the cured adhesive is >500%.

The elongation according to the aforementioned embodiment, is the elongation at break, which is defined as follows:

Elongation at break=(L-L0)/L0*100%,

with L0: Standard length;

L: Length at break.

The elongation is tested at room temperature (25° C.).

All measurements or testing methods in this invention are done at room temperature (25° C.), unless specified otherwise.

Determination of elongation at break is known the person skilled in the art. The elongation measurement can for example be performed according to ASTM D 882 with Instron equipment.

Preferably, the elongation can be determined as follows via a tension tester:

Specimens' preparation:

Sample is prepared by dropping the adhesive composition onto a PET-film with release agent (e.g. coated with silicone release agent) to a given thickness (0.6 mm), irradiating and curing the resin composition with UV light, and then cutting the fully cured sample into a given size of: 0.6 mm*10 mm*50˜60 mm.

Elongation test is preferably done with Instron Equipment (Instron Universal Tester):

Size for the test: 0.6 mm*10 mm*30 mm (20˜30 mm are for the clamping fixture)

Load Force: 1 KN

Speed: 300 mm/min

Especially low values in hardness, shrinkage and elastic modulus can be achieved with inventive adhesive compositions, which comprise

(a) 30 to 45 wt % of urethane acrylate,

(b) 35 to 50 wt % of plasticizer

(c) 0.02 to 3.5 wt %, preferably 1 to 3.5 wt %, in particular 1 to 2 wt % of photo initiator

(d) 15 to 25 wt % of acrylate monomers.

Such adhesive enables a very easy and fast rework of an optical assembly, which was assembled using this inventive adhesive. The adhesive film is easily removable, as the case may be after heating to 50° C.-100° C., from cover lens or display panel, for example, without leaving any residue on the optical assembly at all. The adhesive film can be peeled away in one single piece

A preferred adhesive composition of this invention comprises therefore

(a) 30 to 45 wt % of urethane acrylate,

(b) 35 to 50 wt % of plasticizer

(c) 0.02 to 3.5 wt %, preferably 1 to 3.5 wt % of photo initiator

(d) 15 to 25 wt % of acrylate monomers,

with an elastic modulus of the cured adhesive which is <1.0·10⁴ Pa, preferably determined using photorheometry.

A preferred adhesive composition of this invention comprises therefore

(a) 30 to 45 wt % of urethane acrylate,

(b) 35 to 50 wt % of plasticizer

(c) 0.02 to 3.5 wt %, preferably 1 to 3.5 wt % of photo initiator

(d) 15 to 25 wt % of acrylate monomers,

with a shrinkage of the cured adhesive, which is <1.5%, preferably ≦1%, preferably determined using photorheometry.

A preferred adhesive composition of this invention comprises therefore

(a) 30 to 45 wt % of urethane acrylate,

(b) 35 to 50 wt % of plasticizer

(c) 0.02 to 3.5 wt %, preferably 1 to 3.5 wt % of photo initiator

(d) 15 to 25 wt % of acrylate monomers,

with a hardness of the cured adhesive, which is 0 to 510 (shore 00), preferably 0 to 53 (shore 00), preferably determined in accordance with ASTM D 2240.

A preferred adhesive composition of this invention comprises therefore

(a) 30 to 45 wt % of urethane acrylate,

(b) 35 to 50 wt % of plasticizer

(c) 0.02 to 3.5 wt %, preferably 1 to 3.5 wt % of photo initiator

(d) 15 to 25 wt % of acrylate monomers,

with an elongation of the cured adhesive, which is >500%.

A preferred adhesive composition of this invention comprises therefore

(a) 30 to 45 wt % of urethane acrylate,

(b) 35 to 50 wt % of plasticizer

(c) 0.02 to 3.5 wt %, preferably 1 to 3.5 wt % of photo initiator

(d) 15 to 25 wt % of acrylate monomers,

with a shrinkage of the cured adhesive, which is <1.5%, preferably <1%, preferably determined using photorheometry, a hardness of the cured adhesive, which is 0 to ≦10 (shore 00), preferably 0 to ≦3, (shore 00), preferably determined in accordance with ASTM D 2240, an elastic modulus of the cured adhesive which is <1.0·10⁴ Pa, preferably determined using photorheometry, and an an elongation of the cured adhesive, which is >500%.

The adhesive composition according to this invention can, of course, contain additional optional ingredients. The person skilled in the art is familiar with them.

Especially preferred are additional ingredients selected from tackifier, antifoaming agents, antioxidant, and adhesion promoter.

Tackifiers are well known and are used to increase the tack or other properties of an adhesive. There are many different types of tackifiers but nearly any tackifier can be classified as a rosin resin derived from wood rosin, gum rosin or tall oil rosin; a hydrocarbon resin made from a petroleum based feedstock; or a terpene resin derived from terpene feedstocks of wood or certain fruits. The adhesive may comprise, e.g., from 0.001 wt % to about 20 wt %, from 0.01 wt % to about 15 wt %, or from 0.1 wt % to about 10 wt % of tackifier. The adhesive layer may also be substantially free of tackifier comprising, e.g., from 0.001 wt % to about 5 wt % or from about 0.001 wt % to about 0.5 wt % of tackifier all relative to the total weight of the adhesive. The adhesive may also be completely free of tackifier.

The inventive liquid optically clear photo-curable adhesive can be prepared by mixing all ingredients to obtain a homogeneous mixture away from light.

Another subject matter of this invention is a process for binding a top substrate to a base substrate, in which

(a) the liquid optically clear photo-curable adhesive, as described before, is applied onto the top side of the base substrate,

(b) the top substrate is attached on the adhesive layer of step (a),

(c) the adhesive is hardened by exposure to electromagnetic radiation comprising a wavelength ranging from 200 nm to 700 nm, preferably from 250 nm to 500 nm.

The “base substrate” in the context of this invention means the substrate, on which a top substrate will be attached to. The “base substrate” can be a display panel, for example, or a LCD. The optically clear photo-curable adhesive will be preferably applied on the top side of the base substrate. The “top substrate” is for example a cover lens.

The top substrate, which is preferably a substantially transparent substrate, is attached to the adhesive layer preferably under ambient condition or under vacuum condition. Vacuum conditions are especially preferred to guarantee the best possible bubble-free bonding. If vacuum conditions are used, then the vacuum level should preferably be around <100 Pa, preferably <10 Pa.

As used herein, “substantially transparent” refers to a substrate that is suitable for optical applications, e.g., has' at least 85% transmission over the range of from 380 to 780 nm.

According to a preferred embodiment of the invention the top side of the base substrate is selected from glass and polymer, preferably plastic films, including in particular polyethylene terephthalate, polymethyl(meth)acrylate, and/or triacetate cellulose (TAC). A plastic film is a thin sheet of (preferably polymer and preferably transparent) material used to cover things. A preferred base substrate is a LCD module with polarizer film on top. In a further preferred case the TAC is the top surface of the polarizer. So, in such case, the adhesive will be directly bonded to the TAC surface.

According to another preferred embodiment of the invention the side of the top substrate, which shall be bonded, which is preferably a transparent substrate, is selected from glass and polymer, preferably plastic films, including in particular polyethylene terephthalate, polymethyl(meth)acrylate, and/or TAC.

The base substrate can be a display panel, preferably selected from a liquid crystal display, a plasma display, a light-emitting diode (LED) display, an electrophoretic display, and a cathode ray tube display, according to another preferred embodiment of the invention.

It is especially preferred that the display panel has touch functionality.

According to another preferred embodiment the top substrate is selected from a reflector, cover lens, touch panel, retarder film, retarder glass, a LCD, a lenticular lens, a mirror, an anti-glare or anti-reflective film, an anti-splinter film, a diffuser, or an electromagnetic interference filter. For example for 3D TV applications, a glass or film retarder will be bonded onto a LCD for passive 3D TV, or a TN LCD or lenticular lens is bonded a regular TFT LCD for naked eye 3D.

The adhesive of our invention as well as the process of our invention can be used for any touch panel sensor assembly. It can preferably be used to bond touch panel sensors that require two layers of indium-tin-oxide coated glass. It can preferably be used for cover lens bonding, in particular to fill the air gap in touch panel sensors that utilize a cover lens (such as clear plastic polymethyl(meth)acrylate) and the glass touch panel sensor. It can preferably be used for direct bonding, preferably to directly bond the cover lens to a LCD module.

Of course our invention comprises the possibility that two or more top substrates are bonded one after another on a base substrate, for example starting with a LCD as the base substrate, then bonding one layer of indium-tin-oxide coated glass on the base substrate with help of the liquid optically clear photo-curable adhesive, after that bonding another layer of indium-tin-oxide coated glass on it with the help liquid optically clear photo-curable adhesive, after this bonding a cover lens on it with the help liquid optically clear photo-curable adhesive.

Another subject matter of this invention is a process of making an optical assembly comprising steps (a) to (d):

(a) providing a display panel and a top substrate, preferably a cover lens or touch panel,

(b) disposing an inventive adhesive on the display panel,

(c) attaching the top substrate on the adhesive layer of step (b),

(d) curing the liquid optically clear photo-curable adhesive by exposing it to electromagnetic radiation comprising a wavelength ranging from 200 nm to 700 nm.

In this processes the liquid optically clear photo-curable adhesive should be applied, for example onto the top side of the display panel, such that preferably a 50 μm to 600 μm thick layer of a liquid optically clear adhesive results. Preferably, a continuous layer of the adhesive should be applied.

The application of the optically clear photo-curable adhesive can be done in the usual way; for example by a single or multi nozzle or a slit coater.

Electromagnetic radiation, in particular UV-radiation, can preferably be supplied using a high intensity continuously emitting system such as those available from Fusion UV Systems until the adhesive is fully cured. A metal halide lamp, LED lamp, high-pressure mercury lamp, xenon lamp, Xenon flash lamp etc. can be used for UV-radiation. UV energy should be around 100 to 5,000 mJ/cm2. For example, irradiation can be conducted for seconds to tens of seconds, for example 5-30 seconds, or longer if required. The irradiation power and time can be easily determined by those skilled in the art.

Another subject matter of this invention is a process for reworking an optical assembly, which is assembled using the adhesive according to this invention, preferably according to the aforementioned process of making an optical assembly, comprising steps (a) to (c):

(a) The top substrate, preferably cover lens or touch panel, is detached from the display panel by heating the assembly preferably to about 50° C. to 100° C. and removing the top substrate.

(b) After detaching the top substrate, the detached parts are cooled to room temperature (25° C.).

(c) The residue adhesive film is peeled of from the top substrate and/or the display panel.

The optical assembly preferably comprises a display panel, in particular a display panel, a top substrate, which preferably is a substantially transparent substrate, and an adhesive layer disposed between the display panel and the top substrate.

Another subject matter of this invention is the use of the inventive liquid adhesive composition on displays to fix a touch screen on a base substrate. The base substrate can be a display panel, preferably selected from a liquid crystal display, a plasma display, a light-emitting diode (LED) display, an electrophoretic display, and a cathode ray tube display.

According to another preferred embodiment of the invention the top substrate is selected from a reflector, cover lens, touch panel, retarder film, retarder glass, a LCD, a lenticular lens, a mirror, an anti-glare or anti-reflective film, an anti-splinter film, a diffuser, or an electromagnetic interference filter. For example for 3D TV applications, a glass or film retarder will be bonded onto a LCD for passive 3D TV, or a TN LCD or lenticular lens is bonded a regular TFT LCD for naked eye 3D.

The use of said liquid optically clear photo-curable adhesive for bonding parts of optical assemblies, wherein the cured adhesive is strippable after heating preferably to 50°-100° C., is another subject matter of this invention.

“The cured adhesive is strippable after heating” means that the bondend parts can be detached by heating to preferably about 50° C. to 100° C., and after detaching the detached parts may be cooled to room temperature (25° C.), and then the residue adhesive film can be peeled from one or both of the detached parts, preferably the adhesive film can preferably be peeled away in just one single piece. This definition is also valid for the following embodiments of the invention.

The use of the inventive liquid optically clear photo-curable adhesive for touch panel sensor assembly, preferably to bond touch panel sensors that require two layers of ITO (indium-tin-oxide) coated glass, wherein the cured adhesive is strippable after heating preferably to 50°-100° C., is another subject matter of this invention.

The use of said liquid optically clear photo-curable adhesive for cover lens bonding, preferably to fill the air gap in touch panel sensors that utilize a cover lens and the glass touch panel sensor, wherein the cured adhesive is strippable after heating preferably to 50°-100° C., is another subject matter of this invention.

The use of said liquid optically clear photo-curable adhesive for directly bonding the cover lens to a LCD module, wherein the cured adhesive is strippable after heating preferably to 50°-100° C., is another subject matter of this invention.

The use of said liquid optically clear photo-curable adhesive composition on displays to fix the touch screen on the base substrate, wherein the base substrate can be a display panel, preferably selected from a liquid crystal display, a plasma display, a light-emitting diode (LED) display, an electrophoretic display, and a cathode ray tube display, wherein the cured adhesive is strippable after heating preferably to 50°-100° C., is another subject matter of this invention.

The use of the inventive liquid adhesive composition for a prevention of Mura in optical assemblies is another subject matter of this invention.

Our invention is applicable in all fields of mobile phone, tablet PC, TV, notebook PC, digital camera, photo frame, car navigation, outdoor display etc.

### EXAMPLES

The following liquid optically clear photo-curable adhesive was prepared by mixing all ingredients to obtain a homogeneous mixture away from light.

| | |
|---|---|
| UV-3610ID80 | 39.5% |
| (Urethane Acrylate Oligomer from Nippon Gohsei, | |
| diluted in 20% isodecyl acrylate) | |
| Lauryl acrylate | 18.8% |
| Triethylene glycol bis(2-ethylhexanoate) | 20.5% |
| GI-2000 | 20% |
| (1,2-Polybutadiene Homopolymer; Number-average | |
| molecular weight: 2100; ex Nippon Soda, Tokyo, Japan) | |
| Speedcure TPO | 0.3 wt % |
| (2,4,6-Trimethylbenzoyl diphenyl phosphine oxide) | |
| Irgacure 184D | 0.9 wt % |
| (1-Hydroxycyclohexyl phenyl ketone) | |

This liquid optically clear photo-curable adhesive was used in a process of making an optical assembly (as example a) comprising:

(a) providing a display panel and a cover lens,

(b) disposing the liquid optically clear photo-curable adhesive on the display panel,

(c) applying the cover lens on the adhesive layer of step (b),

(d) exposing the optical assembly to electromagnetic radiation comprising a wavelength ranging from 200 nm to 700 nm.

This liquid optically clear photo-curable adhesive enabled the bonding of the cover lens to the display panel without any Mura problem. Even when stress was imposed to the display panel no Mura could be detected. An optical assembly cured with the inventive adhesive passed various reliability tests (85° C.×1000 hours; 60° C.° and 95% relative humidity×1000 hours; −40° C.×1000 hours; thermal cycle: −40° C. to 85° C.×1000 cycles) without any Mura problem.

The cured adhesive showed the following properties:

Excellent film-forming ability,

High elongation>500%,

Ultra low elastic modulus: <1.0×10⁴Pa,

Ultra low hardness: <10 (Shore 00),

Ultra-low curing shrinkage: <1%.

The inventive optically clear adhesive significantly improved reworkability of the assembled display.

A process for reworking an optical assembly (as example b), which was assembled using the inventive adhesive (see example a) was conducted according to the following steps (a) to (c):

(a) The cover lens was detached from the display panel by heating the assembly to about 90° C. and removing the cover lens.

(b) After detaching the cover lens, the detached parts were cooled to room temperature (25° C.).

(c) The residue adhesive film was peeled of from the cover lens.

The adhesive film was easily removable from the cover lens without leaving any residue on the optical assembly at all. The adhesive film was peeled away in just one single piece.

What is claimed is:

1. Liquid optically clear photo-curable adhesive, which comprises:
(a) 10 to 50 wt % of an urethane acrylate,
(b) 30 to 70 wt % of plasticizer,
(c) 0.002 to 5 wt % of photo initiator,
(d) 1 to 30 wt % of acrylate monomer.

2. Adhesive composition according to claim 1, wherein the urethane acrylate is an aliphatic polyether urethane acrylate or acrylic ester.

3. Adhesive composition according to claim 1, wherein the plasticizer comprises polyisoprene resin, polybutadiene resin, hydrogenated polybutadiene, xylene polymer, hydroxyl-terminated polybutadiene and/or hydroxyl-terminated polyolefin.

4. Adhesive composition according to claim 1, wherein the photo initiator is chosen from 1-hydroxycyclohexyl phenyl ketone, 2-methyl-1-[4-(methylthio)phenyl]-2-morpholino propan-1-one, 2-benzyl-2-N,N-dimethylamino-1-(4-morpholinophenyl)-1-butanone, combination of 1-hydroxy cyclohexyl phenyl ketone and benzophenone, 2,2-dimethoxy-2-phenyl acetophenone, combination of bis(2,6-dimethoxybenzoyl-2,4,4-trimethylpentyl)phosphine oxide and 2-hydroxy-2-methyl-1-phenyl-propan-1-one, bis(2,4,6-trimethyl benzoyl) phenyl phosphine oxide, 2-hydroxy-2-methyl-1-phenyl-1-propane, combination of 2,4,6-trimethylbenzoyldiphenyl-phosphine oxide and 2-hydroxy-2-methyl-1-phenyl-propan-1-one; and 2,4,6-trimethylbenzoyldiphenyl-phosphine oxide.

5. Adhesive composition according to claim 1, wherein the acrylate monomer is chosen from methyl(meth)acrylate, ethyl(meth)acrylate, butyl(methyl)acrylate, 2-(2-ethoxyethoxy) ethyl acrylate, tetrahydrofurfuryl(meth)acrylate, lauryl acrylate, isooctyl acrylate, isodecyl acrylate, 2-phenoxyethyl acrylate, 2-ethylhexyl(meth)acrylate, isobornyl(meth)acrylate, dicyclopentenyloxyethyl(meth)acrylate, dicyclopentadienyl (meth)acrylate, 2-hydroxyethyl(meth)acrylate, 2-hydroxypropyl(meth)acrylate, 2-hydroxybutyl(meth)acrylate, caprolactone acrylate, morpholine(meth)acrylate, hexanediol di(meth)acrylate, ethyleneglycol dimethacrylate, trimethylolpropane triacrylate, pentaerythritol tetraacrylate and combinations thereof.

6. Adhesive composition according to claim 1, wherein the elastic modulus of the cured adhesive is <1.0·10⁴ Pa, preferably determined using photorheometry.

7. Adhesive composition according to claim 1, wherein the shrinkage of the cured adhesive is <1.5%, preferably ≦1%, preferably determined using photorheometry.

8. Adhesive composition according to claim 1, wherein the hardness of the cured adhesive is 0 to ≦10 (shore 00), preferably 0 to ≦3 (shore 00), preferably determined in accordance with ASTM D 2240.

9. Adhesive composition according to claim 1, wherein the elongation of the cured adhesive is >500%.

10. Adhesive composition according to claim 1 comprising:
(a) 30 to 45 wt % of urethane acrylate,
(b) 35 to 50 wt % of plasticizer
(c) 0.02 to 3.5 wt %, of photo initiator
(d) 15 to 25 wt % of acrylate monomers.

11. Adhesive composition according to claim 1, which comprises additional ingredients preferably selected from tackifier, antifoaming agents, antioxidant, and adhesion promoter.

12. A process of making an optical assembly comprising steps (a) to (d):
(a) providing a display panel and a top substrate, preferably a cover lens or touch panel,
(b) disposing an adhesive according to any one of claims 1 to 11 on the display panel,
(c) attaching the top substrate on the adhesive layer of step (b),
(d) curing the liquid optically clear photo-curable adhesive by exposing it to electromagnetic radiation comprising a wavelength ranging from 200 nm to 700 nm.

13. A process for reworking an optical assembly, which is assembled using the adhesive according to claim 1, comprising:
(a) detaching a top substrate from a display panel by heating the optical assembly, and
(b) the detached parts to room temperature (25° C.), and
(c) peeling the adhesive cooling from the top substrate and/or the display panel.
